(19) United States
(12) Patent Application Publication
(10) Pub. No.: US 2022/0149386 A1
(43) Pub. Date: May 12, 2022

(54) ANODE CATALYSTS FOR FUEL CELLS

(71) Applicant: PHILLIPS 66 COMPANY, HOUSTON, TX (US)

(72) Inventors: Mingfei Liu, Bartlesville, OK (US); Ying Liu, Bartlesville, OK (US)

(73) Assignee: PHILLIPS 66 COMPANY, HOUSTON, TX (US)

(21) Appl. No.: 17/510,625

(22) Filed: Oct. 26, 2021

Related U.S. Application Data
(60) Provisional application No. 63/111,259, filed on Nov. 9, 2020.

(51) Int. Cl. H01M 4/90; H01M 8/1213; H01M 4/86

(52) U.S. Cl. CPC H01M 4/9025; H01M 2008/1293; H01M 4/8652; H01M 8/1213

(57) ABSTRACT

A fuel cell comprising a Ni-based anode. The fuel cell also comprises a catalyst, wherein the catalyst comprises a mixture of: NiO, YSZ, BaCO₃, CuO, ZnO, Fe₂O₃, and Cr₂O₃. It is envisioned that the fuel cell is operated at temperatures greater than 600° C.

### CROSS-REFERENCE TO RELATED APPLICATIONS

This application is a non-provisional application which claims the benefit of and priority to U.S. Provisional Application Ser. No. 63/111,259 filed Nov. 9, 2020, entitled “Anode Catalysts for Fuel Cells,” which is hereby incorporated by reference in its entirety

### STATEMENT REGARDING FEDERALLY SPONSORED RESEARCH OR DEVELOPMENT

None.

### FIELD OF THE INVENTION

This invention relates to anode catalysts for fuel cells.

### BACKGROUND OF THE INVENTION

Generally, fuel cell systems such as solid oxide fuel cells requires an upstream, separate reforming process when hydrocarbons such as natural gas, gasoline, diesel, jet fuel, and the like, are used as fuel for the fuel cell. External reforming converts hydrocarbons into a mixture containing hydrogen and carbon monoxide, carbon dioxide, etc., which is also known as reformate. The reformate is subsequently fed into the anode side of the fuel cell stack, such as a Solid Oxide Fuel Cell (SOFC) and is converted to electric energy through the electro-chemical reaction at the surface of the electrode.

Types of external reforming processes include catalytic partial oxidation (CPOX), autothermal reforming (ATR) and steam reforming (SR). Such external reforming processes invariably add volume, cost and operating complexity into the total SOFC power generation system. Moreover, they often consume additional energy in the process of converting hydrocarbons. For example, CPOX and ATR processes require mixing oxidizing gas with hydrocarbons so that a portion of the hydrocarbons is oxidized to generate sufficient heat for the overall catalytic process. External steam reforming is an endothermic process and requires a heat source, which is typically a separate combustor that consumes additional fuel or through a costly heat exchanger. The external reformer not only increases the system complexity but also increases the system cost. In contrast, the hydrocarbon reforming process could be carried out inside the SOFC stack through so-called “internal reforming”, which could utilize the thermo energy released from the SOFC stack to drive the steam reforming reaction.

Fuel cell systems typically operate at above 600° C. which is a suitable temperature for steam reforming. Heat generated through electro-catalytic oxidation over electrodes and ohmic resistance over electrolyte in a fuel cell can be utilized to drive the reforming reaction. Therefore, the internal reforming process does not need a costly external device and heat management system.

The Ni-YSZ anode is the state-of-the-art anode material for SOFCs because of its excellent mechanical stability, sufficient conductivity, and electrocatalytic activity for hydrogen oxidation. However, the performance deteriorates quickly as a result of coke (carbon) formation over the anode surface when operating on hydrocarbon fuels because nickel-based anodes are highly active for catalytic fuel cracking reactions. To avoid potential coking formation on the fuel cell Ni based anode, introducing a large quality of steam (with a steam-to-carbon ratio greater than 2:1) to fuel gas to promote internal reforming. However, the high steam content in the fuel is known to accelerate coarsening of Ni in the anode and may increase cell degradation. Using a higher steam-to-steam ratio increases operating cost. Furthermore, high steam content dilutes fuel which reduces cell performance.

Another way others have tried to solve the problem was by developing non-nickel based anode materials for fuel cells, such as Cu-based cermet, and other oxide-based anodes including La_{0.75}Sr_{0.25}Cr_{0.5}Mn_{0.5}O_{3-δ}, Sr₂Mg₁₋ₓMnₓMoO_{6-δ} (0≤x≤1), doped (La,Sr)(Ti)O₃, and La_{0.4}Sr_{0.6}Ti₁₋ₓMnₓO_{3-δ}. These non-nickel based anode materials indeed demonstrated some improved coking tolerance in hydrocarbon fuels, but the cell performance was typically lower than that of conventional nickel-based anodes. Also, their further applications were stalled by other issues such as low electronic conductivity, low electro-catalytic activity, limited physical, chemical, and thermal compatibility with other cell components, and high price for synthesis. For example, Cu-based cermet required special processing because copper melts below the sintering temperature of most electrolytes, which impedes the fabrication of anode supported fuel cells.

Yet another way others have tried to solve the problem include Infiltrating a catalytic coating, such as samarium doped ceria (SDC), SrZr_{0.95}Y_{0.05}O_{3-δ}, or BaO, into fuel cell anode to modify the catalytic activity of Ni. Such catalytic materials do not drastically alter the performance characteristics of the Ni-based anodes, and good performance has been demonstrated in laboratory scale small button cells. Anode needs to be fully reduced to create porosity for impregnation. This is an extra step for fuel cell fabrication and will also significantly reduce fuel cell strength.

There exists a need for a method for an efficient heterogenous reaction to occur on.

### BRIEF SUMMARY OF THE DISCLOSURE

A fuel cell comprising a Ni-based anode. The fuel cell also comprises a catalyst layer, wherein the catalyst comprises a mixture of: NiO, YSZ, BaCO₃, CuO, ZnO, Fe₂O₃, and Cr₂O₃. It is envisioned that the fuel cell is operated at temperatures greater than 600° C.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts a methane conversation as a function of temperature with a methane flow rate of 100 sccm and a steam-to-carbon ratio of 2:1.

FIG. 2 depicts a methane conversation as a function of temperature with a methane flow rate of 200 sccm and a steam-to-carbon ratio of 2:1.

FIG. 3 depicts a methane conversation as a function of temperature with a methane flow rate of 400 sccm and a steam-to-carbon ratio of 2:1.

FIG. 4 depicts a reforming catalyst layer on fuel cells anode surface.

FIG. 5 depicts the fuel cell power output testing results at 0.8V on natural gas feed with a steam-to-carbon ratio of 2:1.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

The present embodiment describes a fuel cell comprising a Ni-based anode. The fuel cell also comprises a catalyst, wherein the catalyst or catalyst layer comprises a mixture of: NiO, YSZ, BaCO₃, CuO, ZnO, Fe₂O₃, and Cr₂O₃. In this embodiment, it is envisioned that the fuel cell is operates at temperatures greater than 600° C.

The following examples of certain embodiments of the invention are given. Each example is provided by way of explanation of the invention, one of many embodiments of the invention, and the following examples should not be read to limit, or define, the scope of the invention.

### Sample Preparation

Table 1 depicts compositions for catalyst samples that were tested. The baseline composition (sample 1) consisted of 60 g NiO and 40 g YSZ powder.

TABLE 1

| | Sample 1 | Sample 2 | Sample 3 | Sample 4 | Sample 5 |
|---|---|---|---|---|---|
| NiO | 60 | 60 | 60 | 60 | 60 |
| YSZ | 40 | 40 | 40 | 40 | 40 |
| BaCO₃ | | 1.5 | 1.5 | 5.0 | 1.5 |
| CuO | | 1.650 | | | 1.650 |
| ZnO | | 1.700 | | | 1.700 |
| Fe₂O₃ | | | 4.375 | | 4.375 |
| Cr₂O₃ | | | 0.610 | | 0.610 |

The weight ratio 0% of the catalysts are shown below in Table 2

TABLE 2

| | | Preferred | Optimal |
|---|---|---|---|
| | Weight ratio % | weight ratio | weight ratio |
| BaCO₃ | 0.5-10 wt % | 1-5 wt % | 1.3-1.5 wt % |
| CuO | 0.5-10 wt % | 1-5 wt % | 1.4-1.6 wt % |
| ZnO | 0.5-10 wt % | 1-5 wt % | 1.4-1.6 wt % |
| Fe₂O₃ | Greater than 3 wt % | 3-5 wt % | 3.5-4.5 wt % |
| Cr₂O₃ | Less than 1 wt % | Less than 0.8 wt % | 0.5-0.6 wt % |

During the formation of the samples, the catalyst was pre-mixed and annealed at 1200° C. for at least 2 hours prior to use.

### Offline Testing Results

Five grams of each catalyst sample was held in a tubular reactor located in a furnace. A mixture of methane and steam at a pre-determined ratio was introduced to the reactor and part of the exhaust was directed to a GC for real-time monitoring of the off-gas composition.

Samples were heated from room temperature to 750° C. at a rate of 3° C./min under nitrogen. When the reaction temperature was reached, the sample was reduced at 750° C. with hydrogen. after reduction, dry methane was bubbled through a heated humidifier at different flow rates (100-400 sccm). The temperature of the humidifier was set at 89° C. to generate a steam-to-carbon ratio of 2:1. GC data were collected from 750° C. to 500° C. at an interval of 50° C.

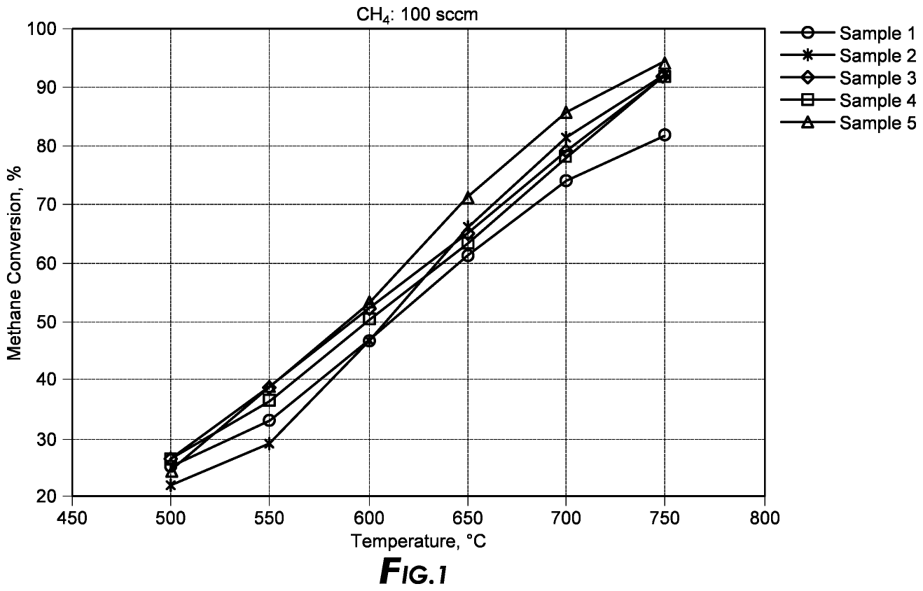

FIG. 1 depicts a methane conversation as a function of temperature with a methane flow rate of 100 sccm and a steam-to-carbon ratio of 2:1.

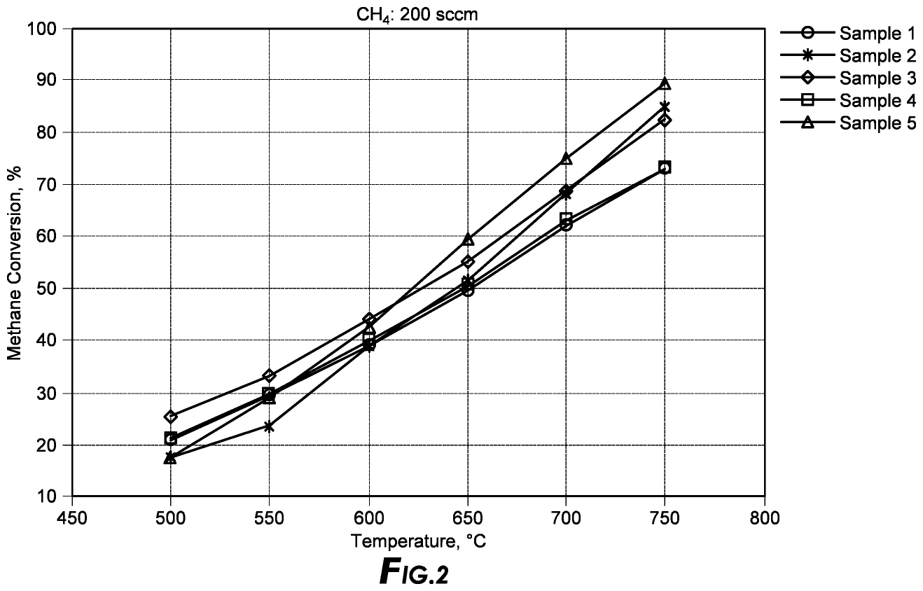

FIG. 2 depicts a methane conversation as a function of temperature with a methane flow rate of 200 sccm and a steam-to-carbon ratio of 2:1.

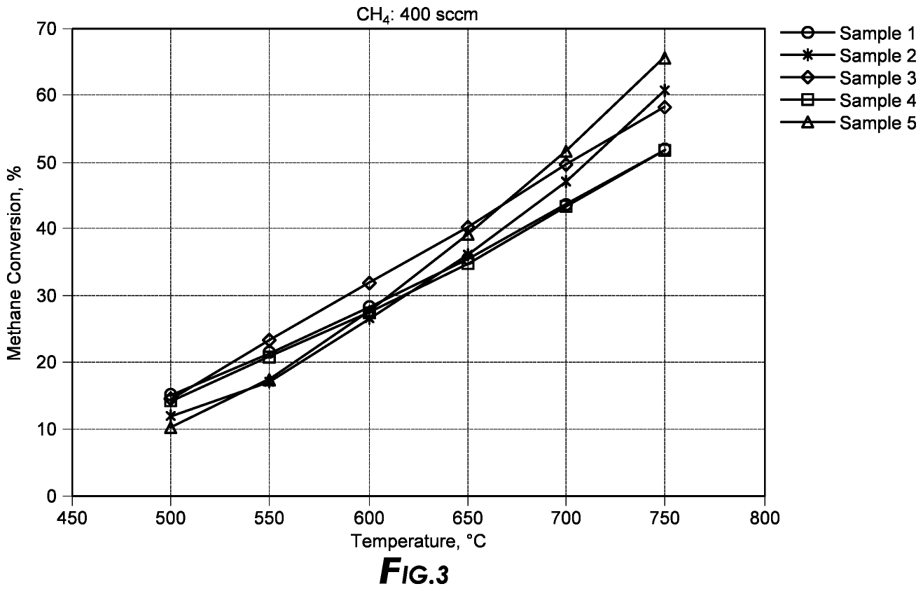

FIG. 3 depicts a Methane conversation as a function of temperature with a methane flow rate of 400 sccm and a steam-to-carbon ratio of 2:1.

### Fuel Cell Testing Results

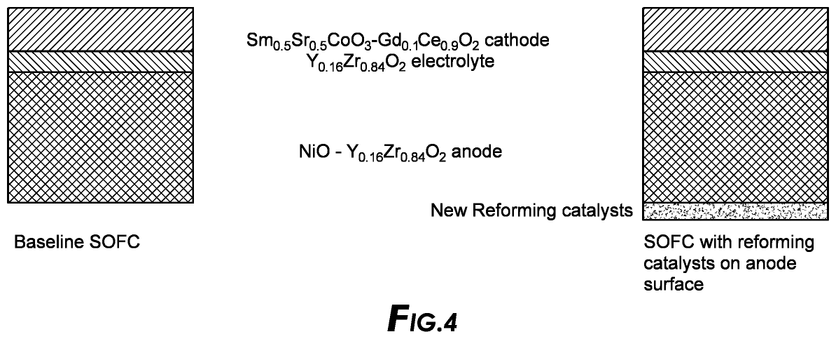

Samples 3 and 5 were selected for fuel cell testing. The catalysts could simply be mixed with the raw anode powders during cell fabrication or layered onto the anode via spray coating or screen printing as shown in FIG. 4. The catalyst coatings on the fuel cell were annealed at 1200° C. for 2 hours prior to fuel cell testing.

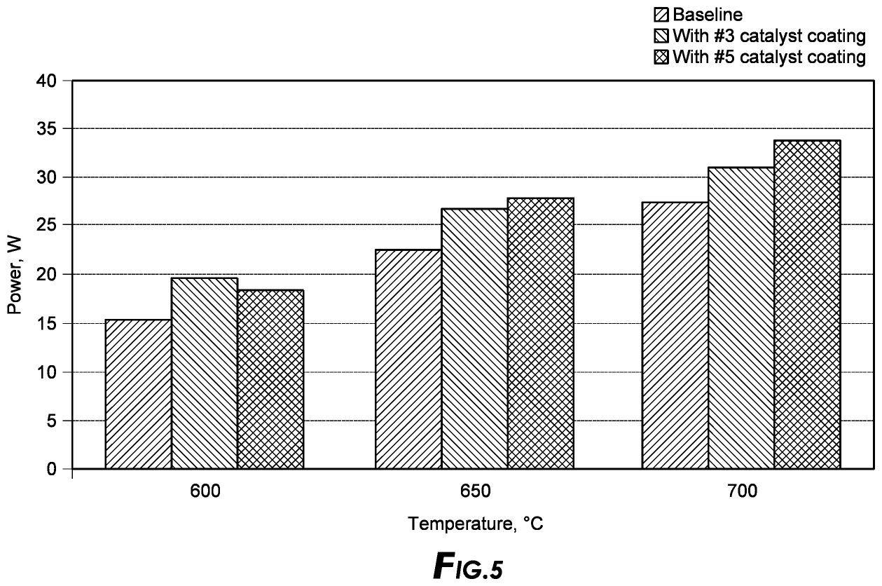

Electrochemical testing was carried out at 600 to 700° C. Natural gas was used as the fuel (0.12 L/min) and ambient air (1.2 L/min) was flowed across the cathode surface. A consist steam-to-carbon ratio of 2:1 was used in all fuel cell tests. FIG. 5 shows the fuel cell power output testing results at 0.8V on natural gas feed with a steam-to-carbon ratio of 2:1. Compared with the baseline cell, catalyst #3 (Cu—Zn—Ba) improved fuel cell performance by 26%, 19%, and 13% at 600, 650, and 700° C., respectively on natural gas fuel, while #5 catalyst (Cu—Zn—Fe—Cr—Ba) improved fuel cell performance by 18%, 24%, and 23% at these temperatures.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A fuel cell comprising:
a Ni-based anode;
a catalyst, wherein the catalyst comprises a mixture of: NiO, YSZ, BaCO₃, CuO, ZnO, Fe₂O₃, and Cr₂O₃;
wherein the fuel cell is operated at temperatures greater than 600° C.

2. The fuel cell of claim 1, wherein the catalyst is incorporated into the anode.

3. The fuel cell of claim 1, wherein the catalyst is layered onto the anode subjacent the anode and superjacent an electrolyte.

4. The fuel cell of claim 1, wherein fuel cell is operated at temperature lower than 750° C.

5. The fuel cell of claim 1, wherein wt % ratio of BaCO₃ in the catalyst ranges from about 1% to about 5%.

6. The fuel cell of claim 1, wherein wt % ratio of CuO in the catalyst ranges from about 1% to about 5%.

7. The fuel cell of claim 1, wherein wt % ratio of ZnO in the catalyst ranges from about 1% to about 5%.

8. The fuel cell of claim 1, wherein wt % ratio of Fe₂O₃ in the catalyst ranges from about 3% to about 5%.

9. The fuel cell of claim 1, wherein wt % ratio of Cr₂CO₃ in the catalyst ranges is less than 1%.

10. The fuel cell of claim 1, wherein during the formation of the catalyst, the catalyst was annealed at 1200° C.
